(19) United States
(12) Patent Application Publication
(10) Pub. No.: US 2025/0175111 A1
(43) Pub. Date: May 29, 2025

(54) SEMICONDUCTOR DEVICE, SWITCHING METHOD AND PROGRAM

(71) Applicant: Renesas Electronics Corporation, Tokyo (JP)

(72) Inventor: Tetsuji TSUDA, Tokyo (JP)

(21) Appl. No.: 18/903,176

(22) Filed: Oct. 1, 2024

(30) Foreign Application Priority Data
Nov. 29, 2023 (JP) 2023-202206

(51) Int. Cl. H02P 29/024; H02P 23/14; H02P 27/08

(52) U.S. Cl. CPC H02P 29/027; H02P 23/14; H02P 27/085

(57) ABSTRACT

A semiconductor device, a switching method, and a program that can prevent an overcurrent from flowing through a winding inside the motor are provided. The semiconductor device 100a, based on at least one of the inductance value and the resistance value of the winding inside the motor 10, a determination unit 363 for determining whether the current value of the winding exceeds the threshold after a predetermined time, based on the determination result of the determination unit 363 comprising a switch unit 364 for switching the control mode of the motor 10.

### CROSS-REFERENCE TO RELATED APPLICATIONS

The disclosure of Japanese Patent Application No. 2023-202206 filed on Nov. 29, 2023, including the specification, drawings and abstract is incorporated herein by reference in its entirety.

### BACKGROUND

The present invention relates to a semiconductor device for switching the control mode of the motor, a switching method, and a program.

It is necessary to rotate the motor at high speed in order to realize miniaturization and high efficiency of the motor for the automobile.

There are disclosed techniques listed below.

### [Patent Document 1] Japanese Unexamined Patent Application Publication No. 2011-188609

Patent Document 1 discloses a square wave control mode when rotating the motor at a high speed.

### SUMMARY

When the motor is rotated at high speed, there is a problem that there is a possibility that an overcurrent flows in the winding inside the motor.

Other objects and novel features will become apparent from the description of this specification and the accompanying drawings.

Semiconductor device according to an embodiment, based on at least one of the inductance value and the resistance value of the winding inside the motor, a determination unit for determining whether the current value of the winding exceeds the threshold value after a predetermined time, based on the determination result of the determination unit comprising a switch unit for switching the control mode of the motor.

Switching method according to an embodiment, based on at least one of the inductance value and the resistance value of the winding inside the motor, a determination step of determining whether the current value of the winding exceeds the threshold value after a predetermined time, based on the determination result of the determination step, and a switching step of switching the control mode of the motor.

Program according to an embodiment, based on at least one of the inductance value and the resistance value of the winding inside the motor, a determination process for determining whether the current value of the winding exceeds the threshold value after a predetermined time, based on the determination result of the determination process, the control mode of the motor It is caused to execute a switching process for switching.

According to the one embodiment, it is possible to provide a semiconductor device, a switching method, and a program that can prevent an overcurrent from flowing in the winding inside the motor.

### BRIEF DESCRIPTION OF THE DRAWINGS

FIG. 1 is a block diagram showing a configuration of a semiconductor device according to a comparative example.

FIG. 2 is a perspective view showing a configuration of IPS (Inductive Position Sensor).

FIG. 3 is a graph showing the time change of the current value of the windings of each phase of the motor.

FIG. 4 is a block diagram showing a configuration of a semiconductor device according to a first embodiment.

FIG. 5 is a block diagram showing a functional configuration of an MCU (Micro Controller Unit) according to the first embodiment.

FIG. 6 is a graph showing the time change of the current value of the winding of the motor.

FIG. 7 is a graph showing the time change of the current value of the winding of the motor.

FIG. 8 is a diagram for explaining the timing of switching the voltage.

FIG. 9 is a diagram for explaining a delay in the timing of switching the voltage.

FIG. 10 is a diagram for explaining a time change of the ideal current value.

FIG. 11 is a diagram for explaining the time change of the actual current value.

FIG. 12 is a flowchart showing an example of the operation of the semiconductor device according to the first embodiment.

FIG. 13 is a diagram for explaining the operation of the semiconductor device according to the first embodiment.

### DETAILED DESCRIPTION

For clarity of explanation, the following description and drawings are appropriately omitted and simplified. In addition, the respective components described the drawings as functional blocks for performing various processes may be configured in terms of hardware, a CPU, a memory, or other circuitry, and in terms of software, may be implemented in programs loaded into the memory, or the like. Accordingly, it will be understood by those skilled in the art that these functional blocks can be implemented in various forms by hardware, software running on hardware, or a combination thereof, and are not limited to anyone. In the drawings, the same elements are denoted by the same reference numerals, and a repetitive description thereof is omitted as necessary.

The programs described above also include a set of instructions (or software code) for causing the computer to perform one or more of the functions described in the embodiments when read into the computer. The program may be stored on a non-temporary computer-readable medium or on a tangible storage medium. By way of example and not limitation, computer-readable media or tangible storage media include: Random Access Memory (RAM), Read Only Memory (ROM), flash memory, Solid State Drive (SSD) or other memory techniques, CD-ROM, Digital Versatile Disc (DVD), Blu-ray disks or other optical disk storage, magnetic cassettes, magnetic tapes, magnetic disk storage or other magnetic storage devices. The program may be transmitted on a temporary computer-readable medium or communication medium. By way of example and not limitation, temporary computer readable media or communication media include electrically, optically, acoustically, or other forms of propagating signals.

### Considerations Leading to an Embodiment

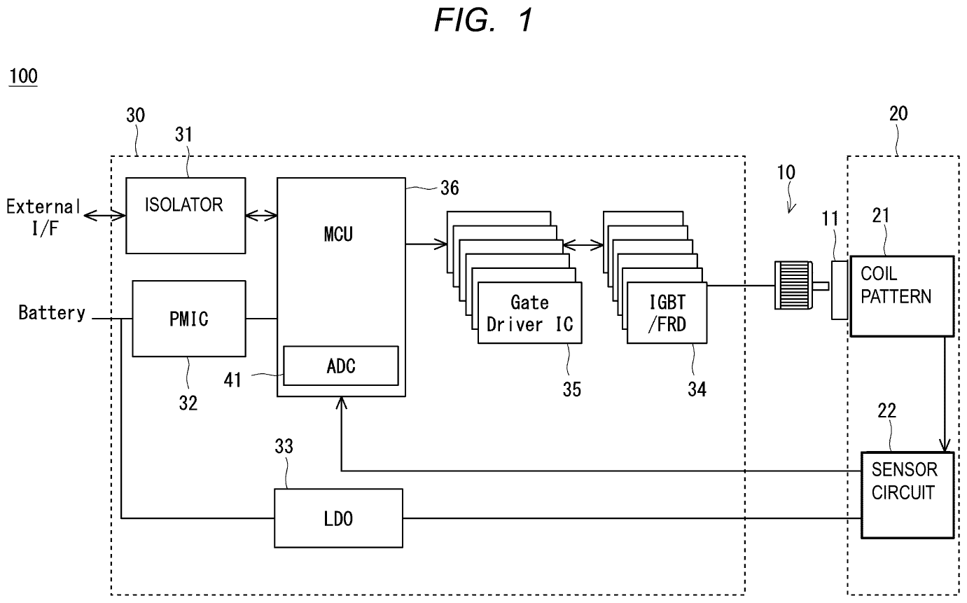

FIG. 1 is a block diagram showing a configuration of a semiconductor device 100 according to a comparative example. The semiconductor device 100 controls the rotation of a motor 10. The semiconductor device 100 includes an IPS (Inductive Position Sensor) 20 and an inverter 30.

Inside the motor 10, a winding for generating a magnetic field is provided. For example, the motor 10 is a three-phase motor, including U-phase windings, V-phase windings, and W-phase windings. The motor 10 may be a two-phase motor, a four-phase or more motor. A target metal 11, which is detected by the IPS 20, is mounted on the shaft or the like of the motor 10.

The IPS 20 provides an analogue signal indicative of the rotational angle of the motor 10 to the inverter 30. The IPS 20 comprises a coil pattern 21 and a sensor circuit 22. The coil pattern 21 includes a transmitting coil and a receiving coil. The sensor circuit 22 outputs a transmission signal to the transmitting coil and obtains a received signal of the receiving coil. Although a resolver may be used in place of the IPS 20, the semiconductor device 100 can be miniaturized by using the IPS 20.

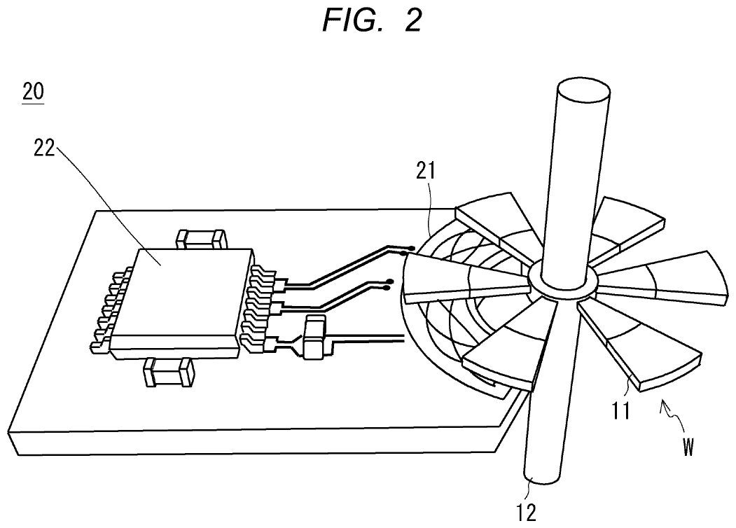

FIG. 2 is a perspective view showing an exemplary configuration of the IPS 20. Feather-like component W is attached to a shaft 12 of the motor 10, the target metal 11 is provided in the component W. The sensor circuit 22 detects the current flowing through the coil pattern 21, and outputs an analog signal indicating the rotation angle of the motor 10.

Referring to FIG. 1, the inverter 30 includes an isolator 31, a PMIC (Power Management Integrated Circuit) 32, an LDO (Low Drop Out) 33, an IGBT (Insulated Gate Bipolar Transistor) 34, a gate driver IC 35, and an MCU (Micro Controller Unit) 36.

The isolator 31 outputs a signal inputted via the external interface to the MCU 36. For example, the isolator 31 is a photocoupler.

The PMIC 32 generates an internal voltage from the voltage of the battery and supplies the generated internal voltage to the MCU 36.

The LDO 33 generates a constant voltage lower than the voltage of the battery and supplies the generated voltage to the IPS 20.

The IGBT 34 generates a voltage across the windings of the motor 10. The IGBT 34, for example, consists of the upper and lower arms of the U-phase, the upper and lower arms of the V-phase, and the upper and lower arms of the W-phase. Any switching element other than IGBT (e.g., MOS transistor) may be used.

The gate driver IC 35 drives the gates of the respective IGBT 34.

The MCU 36 is equipped with an ADC (Analog Digital Converter) 41, which AD converts the analogue signal from the IPS 20 at regular time-intervals. Thus, the MCU 36 obtains a digital signal indicating the rotational angle of the motor 10. When the control mode of the motor 10 is a square wave control mode, the MCU 36 outputs a pulse to the gate driver IC 35 based on the rotational angle of the motor 10. The MCU 36 can also control the motor 10 in a PWM control mode using known techniques.

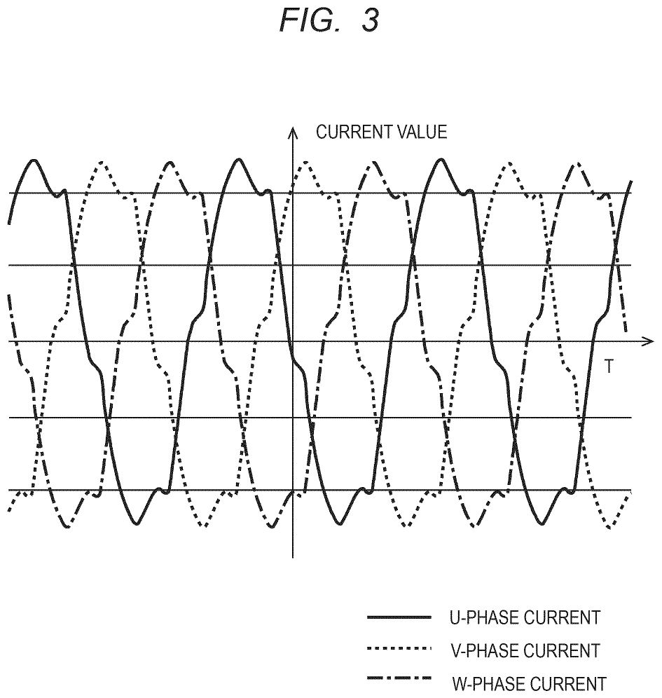

FIG. 3 represents the ideal time variation of the current value of the three phases of the motor 10 controlled by the square wave control mode. The horizontal axis represents time, and the vertical axis represents the current value. Solid line, dotted line, and dashed-dotted line represent U-phase current, V-phase current, W-phase current, respectively. When a current flows in a predetermined direction, the current value is expressed by a positive value, and when a current flows in the opposite direction, the current value is expressed by a negative value. In the ideal case, the amount of fluctuation of the current value in the positive direction is equal to the amount of fluctuation of the current value in the negative direction.

Next, the inventors will be described problems studied. When the motor 10 is controlled in the square wave control mode, the timing at which the MCU 36 switches the output of the pulse may deviate from the idealized timing due to a delay in the process or the like. In this case, the variation amount in the positive direction and the variation amount in the negative direction in FIG. 3 do not match each other, there is a possibility that the current value in the positive direction or the current value in the negative direction exceeds the threshold of the overcurrent. If an overcurrent occurs, in order to protect the winding, the power supply of the semiconductor device 100 is cut off. Therefore, the semiconductor device 100 has a problem that it is difficult to continue the rotation of the motor 10.

### First Embodiment

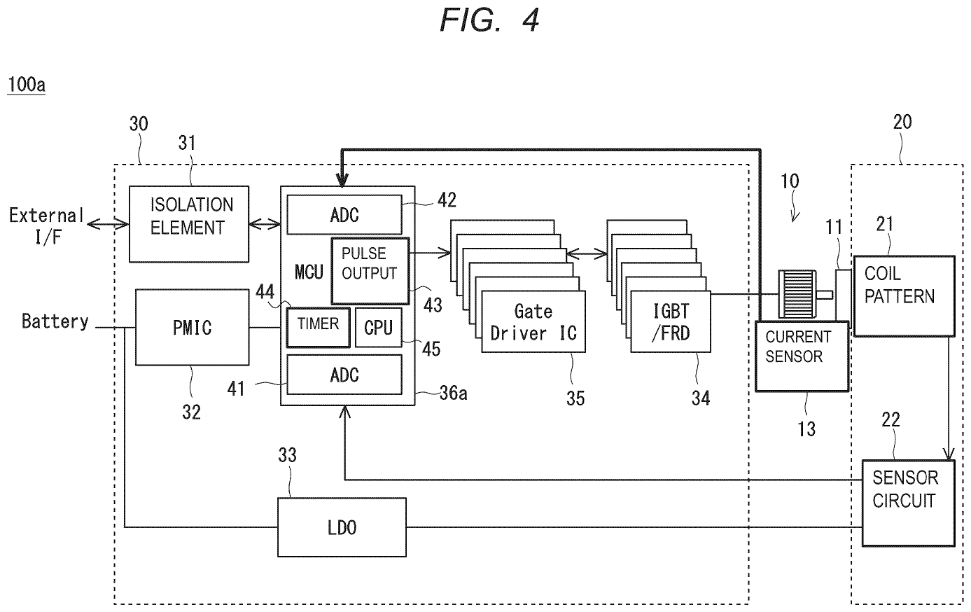

FIG. 4 is a block diagram illustrating a configuration of a semiconductor device 100a according to a first embodiment. With comparison FIGS. 1 and 4, a current sensor 13 has been added to the motor 10, replacing the MCU 36 with an MCU 36a.

A current sensor 13 measures the current value of the windings of the motor 10. The current sensor 13 outputs an analog voltage signal corresponding to the current value to MCU 36a.

The MCU 36a includes an ADC 41, an ADC 42, a pulse output unit 43, a timer 44, and a CPU (Central Processing Unit) 45.

The ADC 41, as described above, AD converts the analogue signal received from the IPS 20 at regular time-intervals to produce a digital signal indicative of the rotational angle of the motor 10. A constant time interval may be measured with the timer 44.

The ADC 42 generates a digital signal indicative of the current reading of the windings of the motor 10 by AD converting the analog signal received from the current sensor 13.

The pulse output unit 43 outputs a pulse to the gate driver IC 35 according to an instruction of the CPU 45.

A timer 44 notifies the CPU 45 at regular intervals. The timer 44 may interrupt the CPU 45 at regular intervals. The constant time may be determined in accordance with the rotational speed of the motor 10. The rotational velocity can be calculated based on the measured IPS 20.

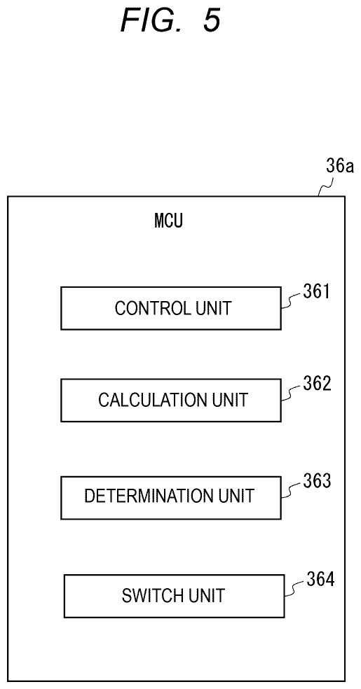

The CPU 45 reads the program from the memory (not shown) and executes, and the MCU 36a realizes a plurality of functions. FIG. 5 is a block diagram showing the functional configuration of the MCU 36a. The MCU 36a includes a control unit 361, a calculation unit 362, a determination unit 363, and a switch unit 364.

The control unit 361 of the MCU 36a outputs a pulse to the pulse output unit 43 according to the control mode of the motor 10. The control mode of the motor 10 is set to a square wave control mode or a PWM control mode. If the control mode is a rectangular wave control mode, the control unit 361 checks the rotation angle of the motor 10 at the timing generated by the timer 44, and controls the output of the pulse corresponding to the rotation angle.

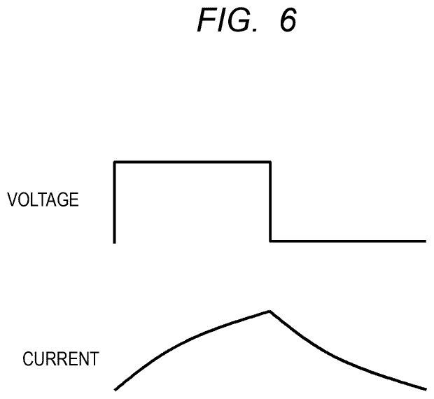

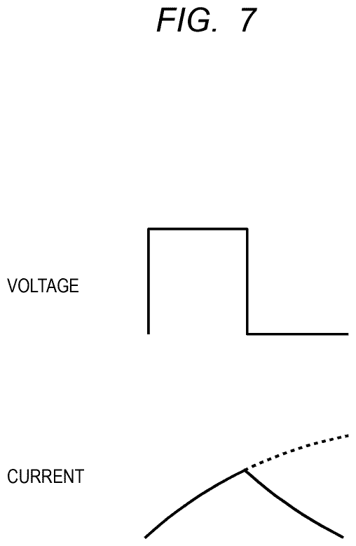

Referring to FIGS. 6 to 11, a description will be given of a rectangular wave control mode. The upper diagram of FIG. 6 represents the time change of the value of the voltage applied to the winding (voltage value), the lower diagram represents the time change of the current value of the winding. The horizontal direction (horizontal axis) in FIG. 6 represents time. The amount of change in the current value per unit time is determined by the resistance value and the inductance value of the winding. Further, as shown in FIG. 7, the maximum value of the current value is determined according to the length of the period in which the voltage value is H level. The horizontal direction (horizontal axis) in FIG. 7 represents time.

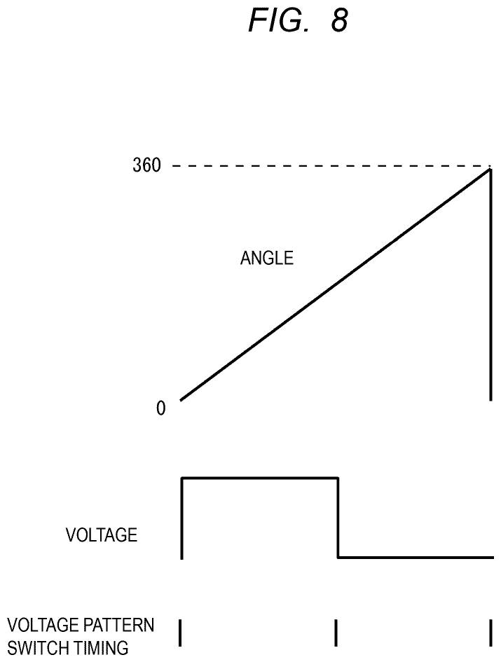

The upper diagram of FIG. 8 shows the time change of the rotation angle of the motor 10, the lower diagram shows an example of an ideal time change of the voltage value. The horizontal direction (horizontal axis) in FIG. 8 represents time. A short straight line extending in the vertical direction in the lower diagram represents the timing of the rise and fall of the voltage value, that is, the switching timing of the voltage pattern. Ideally, the voltage value is switched at this switching timing.

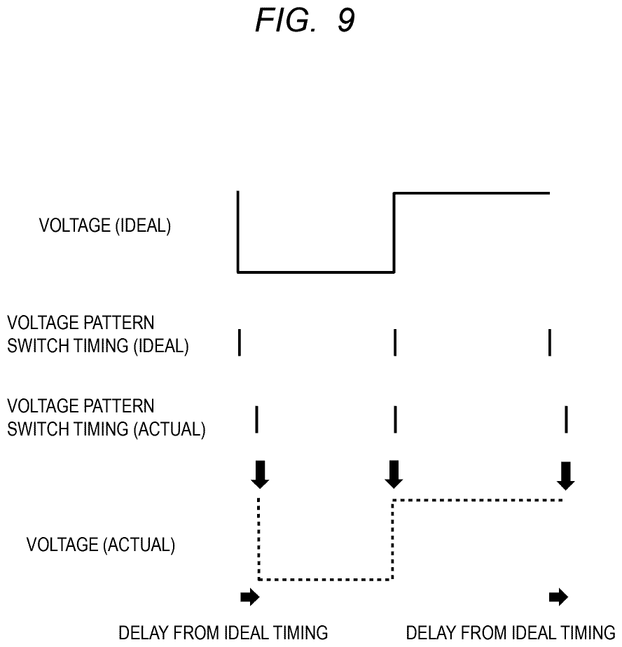

The upper diagram of FIG. 9 represents an ideal time variation of the voltage value of the winding. The lateral direction in FIG. 9 represents time. Actually, due to the delay of the processing or the like, as shown in the lower diagram, there is a case where the timing at which the voltage value of the winding is switched is delayed. Landscape arrow represents the delay amount of the timing of switching the voltage value from the ideal timing.

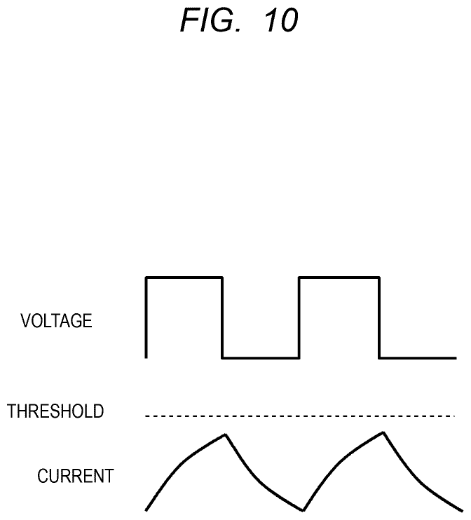

FIG. 10 shows the time variation of the current value when the timing at which the voltage value of the winding is switched is ideal. The horizontal direction (horizontal axis) in FIG. 10 represents time. The upper diagram of FIG. 10 shows the time change of the voltage value, the lower diagram shows the time change of the current value. The dotted line represents the threshold of overcurrent. The current value increases in high voltage period (also referred to as a first period) and decreases in low voltage period (also referred to as a second period). For example, if the rotational speed of the motor 10 is constant and there is no delay described above, the length of the first period and the length of the second period are equal to each other.

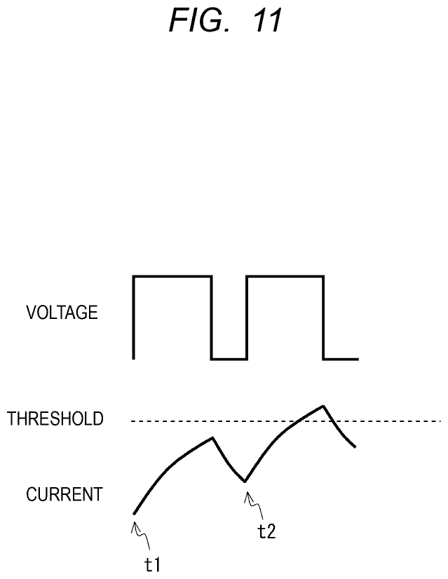

FIG. 11 shows the time variation of the current value when the timing at which the voltage value of the winding is switched is not ideal. The horizontal direction (horizontal axis) in FIG. 11 represents time. For example, if the rotational speed of the motor 10 is constant and there is a delay described above, the length of the first period and the length of the second period are different from each other. When the timing of the first period ends is delayed, the current value of the end t2 of the second period does not return to the current value of the starting t1 of the first period. This may cause the current value to exceed the threshold value. If the current exceeds the threshold value of the overcurrent, the power supply of the semiconductor device 100a is cut off to protect the winding.

Referring to FIG. 5, the calculation unit 362 determines the resistance value of the winding based on the temperature information of the winding of the motor 10. The calculation unit 362 determines the inductance value of the winding based on the current value of the winding of the motor 10. The calculation unit 362 calculates an increase amount of the current value per unit time based on the resistance value and the inductance value. Incidentally, the amount of change in the current value per unit time may be determined in advance based on either the resistance value and the inductance value. In this case, the MCU 36a may not include the calculation unit 362.

The determination unit 363 determines whether the current value of the winding exceeds the threshold value after a constant time based on at least one of the inductance value and the resistance value of the winding. A certain time may be measured by the timer 44. Specifically, the determination unit 363 determines whether the current value of the winding exceeds the threshold value after a certain time based on the increase in the current value of the winding per unit time For example, the determination unit 363 may multiply the increase amount and a constant time of the current value per unit time, and add the multiplication result to the current value based on the measurement result of the current sensor 13.

The switch unit 364 switches the control mode of the motor 10 based on the determination result of the determination unit 363. Specifically, when the current value is determined to exceed the threshold value, the switch unit 364 switches the control mode from the rectangular wave control mode to the PWM control mode. Further, when the current value is determined not to exceed the threshold value, the switch unit 364 switches the control mode from the PWM control mode to the rectangular wave control mode.

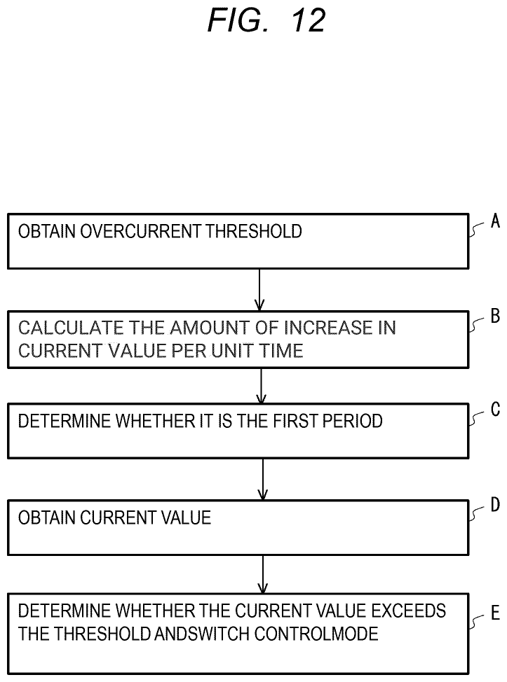

Referring to FIG. 12, an exemplary operation of the semiconductor device 100a will be described. Steps A to B are executed first, and steps C to E are executed at each timing determined by the timer 44.

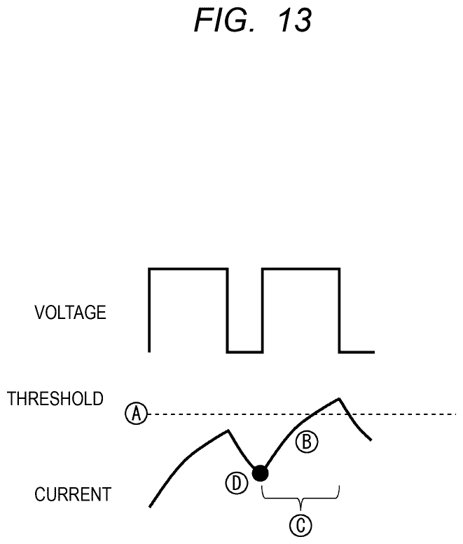

In step A, the MCU 36a of the semiconductor device 100a acquires the threshold of the overcurrent which is set in advance. The threshold may be previously stored in a storage device such as a memory. The threshold corresponds to “A” in FIG. 13. The horizontal direction (horizontal axis) in FIG. 13 represents time.

Referring to FIG. 12, in step B, the calculation unit 362 of the MCU 36a, based on the resistance value determined by the temperature of the winding, and the inductance value determined by the current value of the winding, calculates an increasing amount of the current value per unit time. The curve shown by “B” in FIG. 13 can be approximated by a straight line with a constant slope. This slope corresponds to the amount of increase in the current value per unit time.

Referring to FIG. 12, steps C to E may be performed only when the rotational speed of the motor 10 exceeds a predetermined speed. If the rotational speed of the motor 10 is less than the predetermined speed, the control mode of the motor 10 may be set to the PWM control mode.

In step C, the determination unit 363 of the MCU 36a determines whether or not the respective timings are included in the first time period. “C” in FIG. 13 represents the first period. Steps D to E may be performed only if each timing is included in the first period.

Referring to FIG. 12, in step D, the determination unit 363 of the MCU 36a acquires a current value based on the measurement of the current sensor 13. Referring to FIG. 13, a current value corresponding to the point indicated by “D” is acquired.

Referring to FIG. 12, in step E, the determination unit 363, the amount of increase calculated in step B, and based on the current value obtained in step D, the current value until the next timing it is determined whether or not exceeds the threshold, the switch unit 364 switches the control mode of the motor 10 based on the determination result. The switch unit 364, the control mode is a rectangular wave control mode, and if the current value by the following timing exceeds the threshold, the control mode may be switched to the PWM control mode. Further, the switch unit 364, the control mode is a PWM control mode, and if the current value by the following timing does not exceed the threshold value, the control mode may be switched to the rectangular wave control mode.

In the first embodiment, when the motor 10 is rotated at a high speed, the overcurrent is prevented from flowing in the winding, and the rotation of the motor 10 can be continued. Further, the semiconductor device 100a can realize miniaturization and high-efficiency of the motor 10.

Although the invention made by the present inventor has been specifically described based on the embodiment, the present invention is not limited to the embodiment described above, and it is needless to say that various modifications can be made without departing from the gist thereof.

What is claimed is:

1. A semiconductor device comprising:
a determination unit for determining whether the current value of the winding exceeds a threshold value after a predetermined time based on at least one of the inductance value and the resistance value of the winding inside the motor; and
a switch unit for switching the control mode of the motor Based on the determination result of the determination unit.

2. The semiconductor device according to claim 1,
wherein the switch unit switches the control mode from a rectangular wave control mode to PWM (Pulse Width Modulation) control mode value when the current value is determined to exceed the threshold.

3. The semiconductor device according to claim 1,
wherein the switch unit switches the control mode from PWM control mode to the square wave control mode when the current value is determined not to exceed the threshold value.

4. The semiconductor device according to claim 2 further comprising:
a plurality of switching elements for generating a voltage applied to the winding;
a gate driver for driving the gate of each switching element;
an IPS (Inductive Position Sensor) for measuring the rotational angle of the motor); and
a control unit for controlling the operation of the gate driver based on the control mode and the rotation angle.

5. The semiconductor device according to claim 4,
wherein the determination unit determines whether the timing generated by the timer is within a first period in which the current value increases, and when the timing is within the first period, the current value exceeds the threshold.

6. The semiconductor device according to claim 1 further comprising a calculation unit for calculating an increase amount per unit time of the current value based on the inductance value and the resistance value, comprising,
wherein the determination unit determines whether the current value exceeds the threshold value based on the measurement result of the current sensor for measuring the current value and the increase amount per unit time.

7. The semiconductor device according to claim 2,
wherein the determination unit determines whether the current value exceeds the threshold value when the rotation speed of the motor exceeds a predetermined speed.

8. A switching method comprising:
a determination step of determining whether the current value of the winding exceeds a threshold value after a predetermined time based on at least one of the inductance value and the resistance value of the winding inside the motor; and
a switching step of switching the control mode of the motor based on the determination result of the determination step.

9. A program that causes a computer to run comprising:
a determination process for determining whether the current value of the winding exceeds a threshold value after a predetermined time based on at least one of the inductance value and the resistance value of the winding inside the motor; and
a switching process for switching the control mode of the motor based on the determination result of the determination process.
